(19) United States
(12) Patent Application Publication
(10) Pub. No.: US 2005/0201345 A1
(43) Pub. Date: Sep. 15, 2005

(54) Mobile patient care system

(76) Inventor: Robert D. Williamson, Columbus, OH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/080,280

(22) Filed: Mar. 15, 2005

Related U.S. Application Data
(60) Provisional application No. 60/553,365, filed on Mar. 15, 2004.

(51) Int. Cl. H04Q 7/24

(52) U.S. Cl. 370/338

(57) ABSTRACT

A mobile point-of-care medical station is provided comprising: an interface processor which receives user identification information, a communication interface enabling communication with remote systems via a network, a patient medical parameter processor to acquire data representing a medical parameter of a patient and for processing the patient medical parameter data for presentation to a user on a display and a session initiator for using the communication interface to communicate a message to a session management system. The session management system is employed by the stations and ensures session management compatibility between the stations to initiate generation of a session identifier particular to a user initiated session of operation in response to received user identification information.

### CROSS REFERENCE TO RELATED APPLICATIONS

This is a non-provisional application of provisional application Ser. No. 60/553,365 by Robert Williamson filed Mar. 15, 2004.

### FIELD OF THE INVENTION

The present invention generally relates to systems for use in the field of health care. More particularly, the present invention relates to a mobile point-of-care medical station and a system for its use in a setting such as a hospital ward or care unit.

### BACKGROUND OF THE INVENTION

In hospital wards and other medical care facilities, different types of mobile stations are employed in healthcare delivery at the point-of-care. The different types of mobile stations are used by caregivers, such as nurses, and are typically used for different purposes including, for example, providing a patient with treatment, medication delivery, anesthesia, isolation, emergency and other purposes. Mobile stations used for a particular purpose can differ in configuration between different hospitals. Also within a single hospital, mobile stations used for different purposes can also differ in configuration. The difference in configuration can comprise differences in networking capability, interfacing capability, equipment used and standards employed. For example, different mobile stations may employ different types of personal computers or workstations incorporating different operating systems or different communication interfaces and software. Further, the different mobile stations may employ different medical equipment and accessories such as different bar code scanners, printers, labeling devices and user interfaces. These configuration differences can result in inefficiency in resource usage, part stocking and user training and increase the cost of operating and maintaining the mobile stations.

### SUMMARY OF THE INVENTION

It would be an improvement over the prior art to have a mobile point-of-care medical station configured for use at the point-of-care by a caregiver in a health care setting such as a hospital ward or care unit that can be readily integrated with existing information systems managing the workflow in the hospital ward or care unit. The mobile point-of-care medical station should be free of those limitations and incompatibilities that impede integration in network capabilities, expansion options, access/authentication functions, session control, portal capability, support of executable applications, security and architecture.

A mobile point-of-care medical station that addresses the afore-mentioned deficiencies and associated problems is provided for use by various health care participants, including doctors, nurses, and various other types of caregivers that offers a standardized, common set of communication, user interface, hardware and software capabilities that improve the operational efficiency of the mobile point-of-care medical station and facilitates integration with hospital clinical and administrative information systems and reduces costs. A system can be flexibly configured to support different standards and configurations to support integration of the mobile point-of-care medical station with different hospital information systems as well as different standards and configurations for implementing RFID functions, session control or platform related functions.

According to one aspect of the present invention, a mobile point-of-care medical station provides an interface processor for receiving user identification information, a communication interface enabling communication with remote systems via a network, a patient medical parameter processor for acquiring data representing a medical parameter of a patient and processing the patient medical parameter data for presentation to a user on a display. The system further provides a session initiator for using the communication interface to communicate a message to a session management system, employed by a plurality of mobile point-of-care medical stations and ensuring session management compatibility between medical stations. The session initiator further initiates generation of a session identifier particular to a user initiated session of operation in response to the user identification information received from the interface processor.

### BRIEF DESCRIPTION OF THE DRAWINGS

FIG. 1 illustrates a mobile point-of-care medical station, in a perspective view, in accordance with a preferred embodiment of the present invention;

FIG. 2 illustrates a typical network configuration in which the mobile point-of-care medical station may be implemented;

FIG. 3 illustrates a functional block diagram of the mobile point-of-care medical station; and

FIG. 4 is a display image window of one embodiment of a user interface (UI) screen presented to a user subsequent to the user being authenticated by the mobile point-of-care medical mobile station.

### DEFINITIONS

When the following terms are used herein, the accompanying definitions apply:

client—an information device and/or process running thereon that requests a service of another information device or process running thereon (a “server”) using some kind of protocol and accepts the server's responses. A client is part of a client-server software architecture. For example, a computer requesting the contents of a file from a file server is a client of the file server.

database—one or more structured sets of persistent data, usually associated with software to update and query the data. A simple database might be a single file containing many records, where the individual records use the same set of fields. A database can comprise a map wherein various identifiers are organized according to various factors, such as identity, physical location, location on a network, function, etc.

executable application—code or machine readable instructions for implementing predetermined functions including those of an operating system, healthcare information system, or other information processing system, for example, in response to a user command or input.

executable procedure—a segment of code (machine readable instruction), sub-routine, or other distinct section of code or portion of an executable application for performing one or more particular processes and may include performing operations on received input parameters (or in response to received input parameters) and provide resulting output parameters.

HIPAA—Health Insurance Portability and Accountability Act of 1996, including any amendments or successors thereto.

information—data

network—a coupling of two or more information devices for sharing resources (such as printers or CD-ROMs), exchanging files, or allowing electronic communications there-between. Information devices on a network can be physically and/or communicatively coupled via various wire-line or wireless media, such as cables, telephone lines, power lines, optical fibers, radio waves, microwaves, ultra-wideband waves, light beams, etc.

processor—a processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor.

repository—a memory and/or a database.

object—as used herein comprises a grouping of data, executable instructions or a combination of both or an executable procedure.

patient—one who is scheduled to, has been admitted to, or has received, health care.

server—an information device and/or software that provides some service for other connected information devices via a network.

user interface—a tool and/or device for rendering information to a user and/or requesting information from the user. A user interface includes at least one of textual, graphical, audio, video, animation, and/or haptic elements.

### DETAILED DESCRIPTION OF THE INVENTION

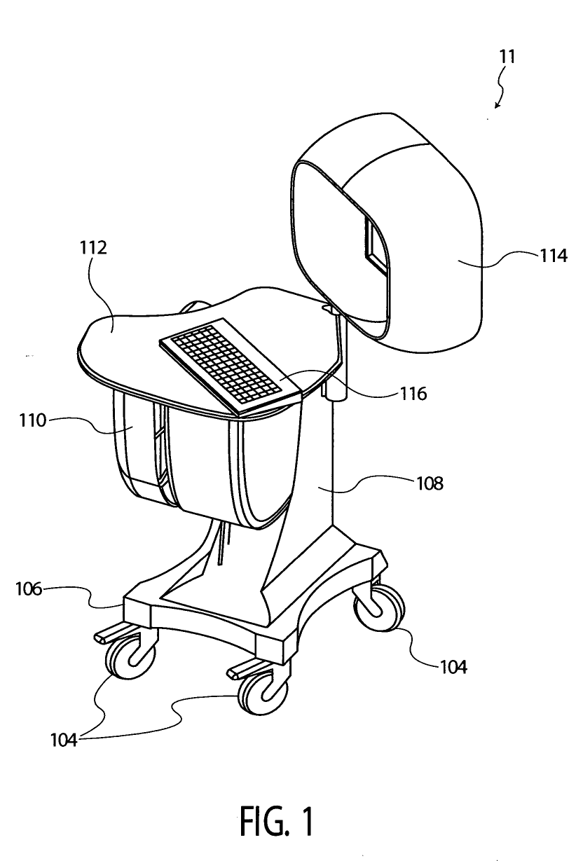

FIG. 1 illustrates a point-of-care medical mobile station 11 (hereinafter called the “station”), in accordance with a preferred embodiment of the present invention. The station 11 is intended for use by doctors of various specialties, nurses, and other caregivers. In a typical application the station 11 is used in a healthcare facility such as, for example, a hospital, a nursing home, or an assisted living care arrangement. The station 11 is intended to support different hospital departments and functions within the healthcare facility including, for example, nursing wards/floors, patient rooms, registration, emergency, pharmacy, treatment, medication delivery, anesthesia isolation and pediatrics. The station 11 may be used in mission critical applications such as, for example, clinical documentation medication administration check, orders, results and/or clinical application-sets.

The station 11 is preferably constructed as a platform like structure and is supported by a number of wheels 104. The FIG. 1 embodiment includes four wheels 104 (one is hidden by the view), which makes the station 11 mobile. In some embodiments, two or more of the wheels may be rotating caster-type wheels, to allow for greater steering in mobility. In the depicted embodiment, the four wheels are rotating caster-type wheels. Alternative embodiments may further include a locking mechanism (not shown) on one or more wheels 104 to prevent unintended movement once the station 11 has been moved to a desired location. Such locking mechanisms may be, for example, a simple wedge, brake, or clamp.

The one or more wheels 104 support a base platform 106 upon which a central support element 108 is mounted. A hydraulic assembly (not shown) is pivotally connected at one end to the central support element 108. The hydraulic assembly is swivel mounted to a bin element 110 at a pivot point (not shown). The bin element 110 may be swiveled (rotated) in a horizontal plane about the pivot point. The station 11 further comprises a workstation rotunda 112 whose underside is connected to, and supported by, the bin element 110 and central support element 108. In a preferred embodiment, the workstation rotunda 112 is tri-tiered, however, a single tiered workstation rotunda is shown in FIG. 1.

The hydraulic assembly is pivotally connected to an underside of the workstation rotunda 112 to provide hydraulic lift. The workstation rotunda 112 provides desktop/file, mid-device and high weight monitor support. The station 11 may also include a privacy visor 114 mounted on the workstation rotunda 112 to provide a low energy backlight which affords private viewing of screen options on the monitor.

Internal to the bin element 110 there is an improved medication dispensing unit. The medication dispensing unit comprises a housing having a plurality of drawers for normally locked storage of pharmaceutical items. A control unit on the housing is programmed upon keyboard entry of a predetermined access code to unlock the drawers one at a time, thereby permitting controlled access to the contents of the drawer. The control unit functions to generate and store an access record. The pharmaceutical items may include medications, controlled medical supplies, medical supplies or items of a nature consistent with a health care facility. Implementation of the controlled dispensing apparatus provides a health care facility with evidence that policy and procedures are being adhered to, as well as providing an audit trail of the override activities associated with computer-controlled medication.

Housed within the central support element 108, the station 11 further includes a slim-line PC base unit, an (802.11a, b, g) network and an RFID interactive system. In a preferred embodiment, the slim-line PC base unit is an ultra low power computer consuming on the order of 6w of power and utilizing at a minimum a processor such as a Pentium II 1.2 GHz processor with 256 MB RAM, and preferably 512, MB RAM. Of course, as technology changes, other processors having increased processing capabilities and lower power consumption ratings may be preferable in the future.

The PC base unit preferably runs on an operating system such as 2000 Professional™, XP Professional™, NT terminal Server™, 2000 Terminal Server™ or Thin-Client CITRIX™. Obviously, as technology changes, other operating systems may be preferable in the future.

In certain embodiments, preferred utility applications utilized on the station 11 desktop include, Microsoft Access 2000™ (full version) for UDA report writer, Microsoft Access™ 2000 (runtime included) and Client for Microsoft Networks™.

In a preferred embodiment, the station 11 operates from a hot swappable 24/hr dual sided battery (not shown) where the two batteries are individually rated for 16 hours of total running capability providing a combined capability on the order of 24/hrs. A retractable electrical power cord with safe shut-down of the 24/hr battery is mounted within the cavity of the base platform 106. The power cord may then be connected to an electrical power source, such as a standard 120 volt electrical outlet. The station 11 includes a further option to use a fuel cell as a battery source. Of course, as technology changes, other power sources may be preferable in the future.

The station 11 is preferably designed to comply with the requirements of safety standard UL2601 for use within approximately 4-5 feet of a patient. To insure the safe handling of biohazard materials, the components within the station 11 are sealed.

In a configuration that supports the tri-tiered workstation rotunda 112, discussed above, the rotunda 112 is capable of supporting a bar code scanner, a biometric mouse, a keyboard 116 as shown, a VoIP call center and a high resolution monitor for displaying in high or selectable image resolution, vital signs and images. A serviceable high resolution monitor, can be, for example, a 15″, 17″, 21″ or 24″ LCD flat-panel screen having a resolution on the order of 1280×1024.

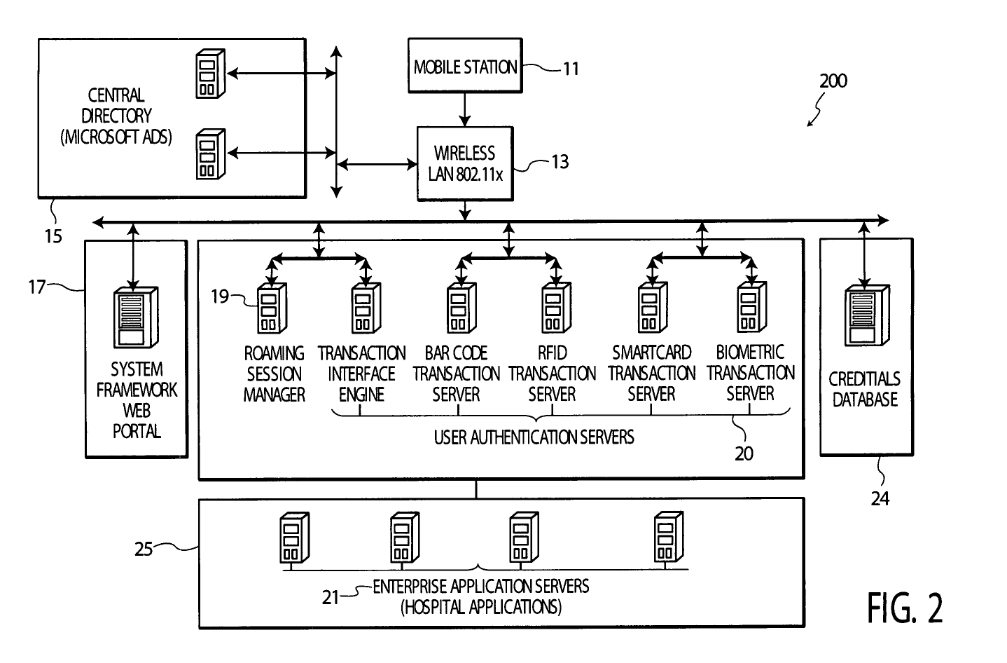

FIG. 2 illustrates a typical network configuration 200 in which the station 11 may be implemented. It should be understood that in a typical setting, many stations 11 may be in use by various caregivers, however one station 11 is shown for ease of explanation. The station 11 is shown connected to a local area network 13 which connects a central directory 15, a system framework web portal server 17, a roaming session manager server 19, a credentials database 24 and a plurality of user authentication servers 20. The authentication servers 20 are shown operatively coupled to a plurality of enterprise application servers 21 storing clinical and executive applications of a healthcare information system 25.

The station 11 is capable of communicating with the various system elements (15, 17, 19, 20, 24) shown in FIG. 2 via the local area network (LAN) 13 using wired or wireless communication means. The wireless communication means may include any number of wireless options, including, without limitation, 802.11, wireless Ethernet, Bluetooth, Bluetooth wireless local area network protocols and Ultra WideBand (UWB). It is noted that, as used herein, the term “802.11” is used to refer collectively to the original IEEE 802.11 standard and its variants and extensions, unless specifically noted otherwise. It should be understood by one skilled in the relevant art that different transmission modes and frequencies may be used by the wireless communications system for the transmissions to and from the station 11. The station 11 also supports VoIP (Voice over IP) communication via a VoIP call center (not shown).

Ultra wide band (UWB) technology is one of the preferred wireless options for use by the station 11 to communicate with the enterprise application servers 21 of the hospital information system 25. UWB technology is a preferred technology in that it does not interfere with digital or analog devices which are used in devices located throughout a healthcare facility. Further, as is known to those knowledgeable in the art, a desirable feature of UWB technology is its immunity to interception, which ensures secure transmission of patient information and supports HIPAA compliance. With its large data carrying capacity and ultra-low power consumption, UWB is ideally suited for healthcare environments.

The user authentication servers 20 are used to authenticate users of the system and include a transaction interface engine, a bar code transaction server, an RFID transaction server, a smartcard transaction server and a biometric transaction server.

The central directory 15 is embodied in the network configuration shown in FIG. 2 with Microsoft automated deployment service (ADS) and acts as the center point of the network 200. Microsoft ADS facilitates the building and administration of very large, scaled out deployments of Windows servers. The central directory 15 is responsible for performing a number of critical functions including storing basic definitions of what is required of a user to login to the station 11. It carries out this function by providing a login script that is accessible and utilized by the station 11 when a user presents himself or herself to the station 11 to be authenticated.

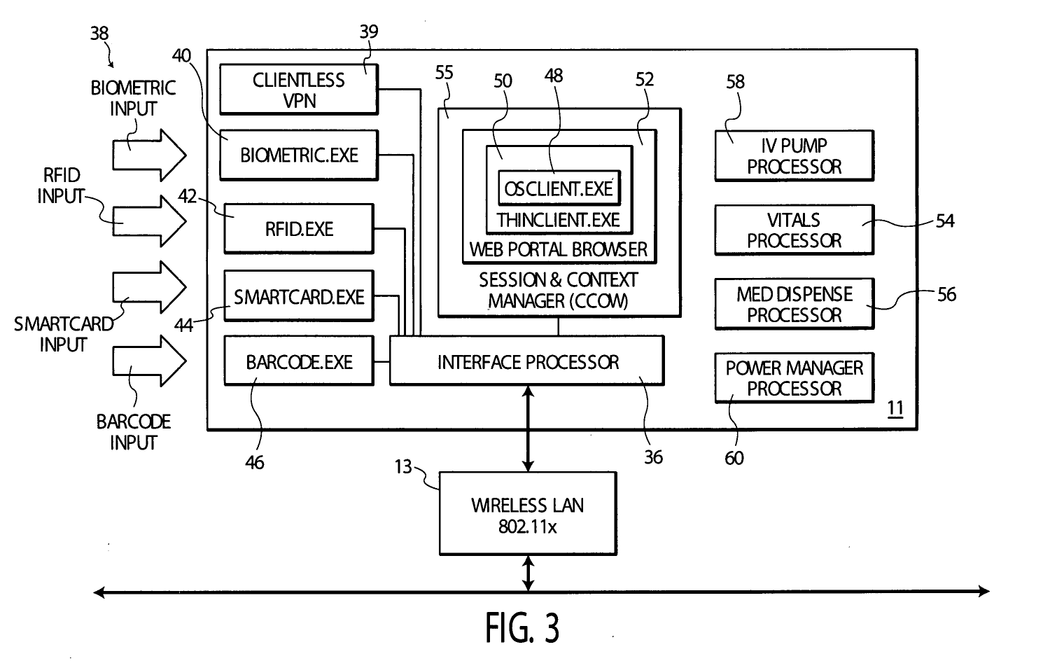

The system framework web portal 17 provides a web portal in a Web portal browser 52 of the station 11, as shown in FIG. 3. As is known to those skilled in the relevant art, web portals provide a mechanism for a user to receive targeted and personalized content. Once a user has been authenticated by the system 200, the system framework web portal 17 places a framework around particular hospital applications stored on the enterprise application servers 21 of the hospital information system 25 that a user has access rights to. In use, once a user is fully authenticated by the system 200, the system framework is retrieved at the system framework web portal 17 for display on the web portal browser 52 of the station 11. The system framework displayed to the user includes those hospital applications 21 that a user has access rights to.

The various user authentication servers 20 communicate with corresponding authentication executable modules (as shown in FIG. 3) in the station 11 to authenticate users. For example, the bar code transaction server communicates with the barcode executable module (barcode.exe 46) in the station 11.

The credentials database 24 stores credentials for users of the system including, without limitation, a user's biometric data, the user's RF identification data, the user's smartcard information. It provides a high level of authentication fault tolerance in the system 200 by serving as a single repository which is referenced by the various authentication servers 20 during the process of authentication.

In one embodiment, printers configured in accordance with the Bluetooth standard may be located throughout a healthcare facility so that when a station 11 is moved in proximity to one of the printers, the station 11 is capable of printing to the local printer wirelessly.

FIG. 3 is a functional block diagram of the station 11 including various interfaces, executable modules and processors, to be described. The station 11 includes a hierarchical software platform including at its core an operating system executable module (OSCLient.exe 48). Successive layers of the hierarchical software platform include a roaming session manager executable module (ThinClient.exe 50), a Web Portal Browser 52 which acts in the capacity of content manager and a session and context manager (CCOW 55). The session and context manager 55 is supported in accordance with the CCOW Standard (CCOW=clinical context object workgroup) in order to process data of the same data record in the hospital applications 21 of a hospital information system 25. The session and context manager (CCOW 55) in accordance with the CCOW standard, seamlessly provides necessary context information including patient and user identifiers, for example, supporting access of data across different executable applications. The hospital applications 21 of the hospital information system 25 sign on to the session and context manager (CCOW 55). In the case where a further data record is loaded into one of these applications 21, the application transfers unambiguous identifiers of the newly loaded data record to the session and context manager (CCOW 55). The session and context manager (CCOW 55) passes this information on to the other active hospital applications 21.

The station 11 also includes other processors including a patient medical parameter processor (i.e., Vitals Processor 54) and multiple interface processors—a biometric processor (biometric.exe 40), a radio frequency identification processor (RFID.exe 42), a smartcard processor (smartcard.exe 44) and a barcode processor (barcode.exe 46) which receive user identification information from corresponding user identification inputs, collectively labeled 38. The respective processors 4046 output user identification information to an interface processor 36 which serves to couple the user identification information from the processors 40-46 to the wireless LAN 13 which enables communication with the various system elements (15, 17, 19, 20 and 24).

The interface processors (40-46), vitals processor 54 and interface processor 36 are selected from a common set of components used by the plurality of stations 11 to ensure compatibility between the stations 11. The interface processors (40-46), vitals processor 54 and interface processor 36 are advantageously adaptive to provide a station 11 suitable for a selected function. The selected functions may include, without limitation, treatment, medication delivery, anesthesia, isolation, emergency, laboratory, nursing, intensive care and pediatrics.

In certain embodiments, it may be desirable to encrypt data as it is being communicated from the various user interfaces 38 via the station 11 to the system elements (15, 17, 19, 20 and 24). Encryption may also be desirable to encrypt hospital application data provided from the various enterprise application servers 21 to the station 11. The station 11 provides an encryption capability embodied as clientless virtual private network (VPN) software 39, (e.g., Citrix software).

The operating system executable module (OSCLIENT.exe 48) represents the core of the hierarchical software platform and coordinates communication activity between the authentication inputs being received by the interface processors (40-46) on one side and the network 200 on the other side. For example, the OSCLIENT.exe module 48 communicates with the central directory 15 to coordinate login and logout activities for the various users of the system providing user identification information 38 via various inputs.

The Thin Client executable module (ThinClient.exe 50), which resides at the next outer layer of the hierarchical software platform above the osclient.exe module 48, is preferably embodied as a Citrix client. The ThinClient.exe module 50 is launched by the OSCUENT.exe module 48 and serves two functions. The first function is to act as a roaming session manager to search the network 200 for a user's last session (i.e., the last station the user was logged on at) and direct that session to whatever station lI the user is currently logged into.

The second function is to act as a terminal emulator for a client/server software portion of a display interface of the station 11. As a user moves from patient/station to patient/station, the ThinClient.exe module 50 moves a session identifier with the user. The session identifier is the user's login profile used to keep a single sign-on session active while the session is temporarily suspended (i.e., while the user is moving between stations). Parameters are set to eventually log the user out if the user does not reactivate the session at another station within a prescribed period of time.

The web portal browser 52 resides at the next outer layer of the hierarchical software platform above the thin client executable module (ThinClient.exe 50). It is launched by the ThinClient.exe module 50 and acts as a thin client to the ThinClient.exe module 50. The web portal browser 52 displays a health enterprise Dashboard screen to the user which is divided into a number of screen partitions corresponding to particular hospital applications the user is authorized to access. For example, for individual applications of a physician as user, the Dashboard screen may include partitions dedicated to radiology, lab pharmacy and clinical documentation, the various partitions constituting some portion of the screen real-estate. The Dashboard screen display fills the various partitions (radiology, lab pharmacy, clinical documentation) with information of a plurality of patients under the care of the physician. However, once the physician makes a specific request for patient data of a particular patient, the specific patient data is shown in the various screen partitions. The particular patient data is retrieved in the following manner.

The web portal browser 52, acting in the capacity of thin client to the ThinClient.exe module 50, makes a call to the ThinClient.exe module 50 which triggers the roaming session manager 19 (FIG. 2) to find the station 11 where the user's session currently resides which is the last station 11 at which the user's session was running. Upon determining the location of the user's current session, the web portal browser 52 instructs the roaming session manager 19 to locate the context manager of the user and the user's associated applications. The context manager is a screen manager and organizer that represents the engine that pulls information (i.e., application data) from multiple sources to populate the Dashboard screen provided by the web portal browser 52. The application data from the multiple sources populate a screen display on a display screen of the station 11 where the user is currently logged into. It should be understood that for a typical application, the application data that is retrieved for display on the Dashboard screen is an opening screen. In the case of an opening screen constituting a large front end with a large number of fields, a portion of the fields are retrieved.

The context manger (CCOW 55) utilizes a login procedure that supports authentication enabling a user to concurrently access multiple executable applications for the purpose of pulling information (application data) without the need to enter a password and user identification information for the multiple applications.

In addition to its role as context manager in pulling information (i.e., application data) from multiple sources to populate the Dashboard screen provided by the web portal browser 52, the session and context manager (CCOW 55) also acts as a session initiator. Specifically, as session initiator, the session and context manager (CCOW 55) operates together with the thinClient.exe module 50 ensuring session management compatibility between the various stations 11. The session and context manager (CCOW 55) initiates a session by prompting the roaming session manager 19 to generate a session identifier particular to a user initiated session of operation of an executable application accessed by a user of a particular station in the network.

A user initiated session begins with identification information received from the user via one of the previously described user inputs 38. In response to receiving the identification information from the user at a station 11, a user session is initiated by the session and context manager (CCOW 55). As a session initiator, the session and context manager (CCOW 55) communicates a message, including the identification information, to the roaming session manager 19 via the station's interface processor 36. The roaming session manager 19 serves the role of session management system. In response to receiving the communicated message at the roaming session manager 19, it sends a return message, via interface processor 36, including a generated session identifier particular to the user initiated session of operation to uniquely identify the user initiated session. It is noted that the generated session identifiers have unique values but are of a similar data format.

Once a user session has been initiated, whenever the user moves from a first patient/station to a second patient/station, the context manager (CCOW 55), via the interface processor 36, communicates a message to the roaming session manager 19 to initiate detachment of an existing session of operation of an executable application from the first patient/station to initiate connection to the second patient/station.

In certain embodiments, the station 11 may also include a vitals processor 54 for processing patient vitals including, glucose, temperature data, blood parameter data, ventilation parameter data, blood pressure data, pulse rate data, infusion pump related data, temperature data and respiratory data.

In certain embodiments, the station 11 may include an IV pump processor 58 for monitoring the distribution of IV fluids to a patient.

The station 11 includes a power management processor 60 which operates together with the operating system executable module (OSCLient.exe 48) to safely power up/down the station 11.

The biometric (biometric.exe 40), RFID (RFID.exe 42), smartcard (smartcard. Exe 44) and barcode (barcode.exe 46) executable modules are configured to receive user identification information 38 from users. The identification information is output to an interface processor 36 to carry out single sign-on functionality. The interface processor 36 is also configured to receive user initiated requests to access an executable application stored on one or more of the enterprise application servers 21.

The station 11 provides a capability for single sign-on requiring no passwords or usernames. Authentication can be either single tier or multi-tiered.

Single tier authentication is typically used to authenticate patients or asset based transactions (e.g., dispensing band aids, gauzes, etc.) while multi-tier authentication is required for certain personnel having a variety of roles, including doctors of various specialties, nurses and other hospital staff. Such personnel are provided access to confidential patient information and require stronger authentication (at least a first and second tier of authentication) and sometimes three or tiers of authentication than a patient or an asset based transaction. It is noted that multi-tier authentication is required to support authorization and management of user access to patient medical information as well as HIPAA compliant auditing and tracking of such access.

The authentication methods contemplated for use by the station 11 include, without limitation, biometrics, RFID, bar codes, smartcards and magnetic strip. Other well known authentication methods known in the art are also contemplated for use for purposes of authentication.

RFID authentication is a preferred first tier authentication method. To implement RFID authentication, one or more RFID identification badges (tags) are generated for distribution to users. The RFID identification badges are preferably encoded with identification information to enable the users to seamlessly log-on to the station 11. Log-on is accomplished using a wireless data transmitter in response to proximity detection by the station 11 without requiring the user to enter a password or user ID. In certain embodiments, the RFID identification badge may itself incorporate a biometric sensor so that the RFID tag itself may be activated by a particular user.

When a user wearing an RFID identification badge moves within a reasonable proximity of the station 11 (e.g., 4-5 feet), an RFID sensor in the station 11 is activated by the RFID identification badge worn by the user. The process that follows is different for different levels of authentication.

In the case of a low-level (single tier) authentication, upon detection of the user by the RFID sensor in the station 11, the station 11 automatically identifies its own geographical location (e.g., hospital floor and room) and the location of the user and seizes and secures a session of operation involving one or more hospital applications 21 involving the user desiring to be authenticated.

In the case of a multi-tier authentication, in addition to submitting to a first level identification procedure (e.g., RFID), a user further submits to at least a second level of authentication. The second level of authentication could be any of the authentication techniques described above or any other well-known authentication techniques in the art. For example, when biometric information is used as a second tier authentication method, the user submits to a well known biometric test, such as, for example, a fingerprint, voice, iris, retina, hand, face, or other personal characteristics. The system 200 accepts unique biometric information from the user and identifies the user by matching the information against information belonging to registered users of the system.

In certain special cases, a third level of authentication may be required. For example, an institution may require three levels of authentication to provide the highest level of security. When three levels of authentication are required, typically a combination of RFID, smartcard and biometric authentication is employed. However, when medical dispensing is involved (e.g., attaching an IV bag, distributing a medication, distributing an IV bag) bar coding authentication is typically involved as one level of authentication. For example, when a single dose package of medication is dispensed from a locked drawer of the bin element 110 of the station 11, the single dose package includes a bar code which is scanned to ensure it is the correct medication given at the appropriate time for the patient.

It should be appreciated that the station 11 may be configured to utilize any of the known authentication methods for use at the 1^{st}, 2^{nd} and 3^{rd} tier of authentication.

By way of example, assume that an RFID authentication test is used at a first tier test of authentication. In this case, an RFID identification badge on a user communicates via an RFID input 38 (i.e., an RF signal) with the RFID.exe module 42 of the station 11. The RFID.exe module 42 is launched to perform necessary steps to identify the user. Upon being launched, the RFID.exe module 42 communicates with the operating system executable module (OSCLIENT.exe module 48) to inform the OSCLIENT.exe module 48 that it has been launched and to forward the identification characters stored on the RFID identification badge to the central directory 15. The number of characters transmitted differs from state to state and may include parameters such as, for example, the patient's social security number of a patient's identification number which is placed on the patient's wristband when admitted.

Once a user has passed the first tier of authentication, the thin client executable module (thinclient.exe 50), moves the intended user's primary active session from the last active remote station to the station at the current location. Moving the primary active session from the last active station to a current location constitutes a session management activity. This “roaming session” transfer activity is performed in a background mode, transparent to the user. The current roaming session is made ready at the station 11 at the current user location for single sign-on in anticipation of a successful result at the 2^{nd} and/or 3^{rd} tier of authentication. The 2^{nd} and/or 3^{rd} tier authentication may be performed using any well known method including, for example, biometric, smartcard or bar code, as described above. As part of the preferred embodiment's overall design, roaming activity is normally hidden from the users and thus a user generally does not get informed of (or even need to know about) the details concerning roaming.

A roaming session provides a number of distinct advantages including, enabling a user to move from location to location, computer to computer, while continuing to work on the same record, enabling two or more users to share terminals and pick up on individual sessions where the two or more users left off and when coupled with a remote access strategy, enabling a user to log in remotely from the home or office and resume their session at the same point they last ended.

Thereafter, when the user has finished interacting with the station 11 and steps outside the prescribed perimeter (e.g., 4-5 feet) of the station 11, the session management system suspends and secures the session ready for re-activation or movement to another workstation and location. It is noted that unlike prior art systems which do not guarantee a secure logout, RFID detection (i.e., stepping inside and outside the prescribed perimeter) provides a secure logout that automatically suspends a user's session the instant the user steps outside the prescribed perimeter (e.g., 4-5 feet) of the station 11. Reentering the perimeter requires the user to provide one or more levels of authentication to re-establish the suspended session.

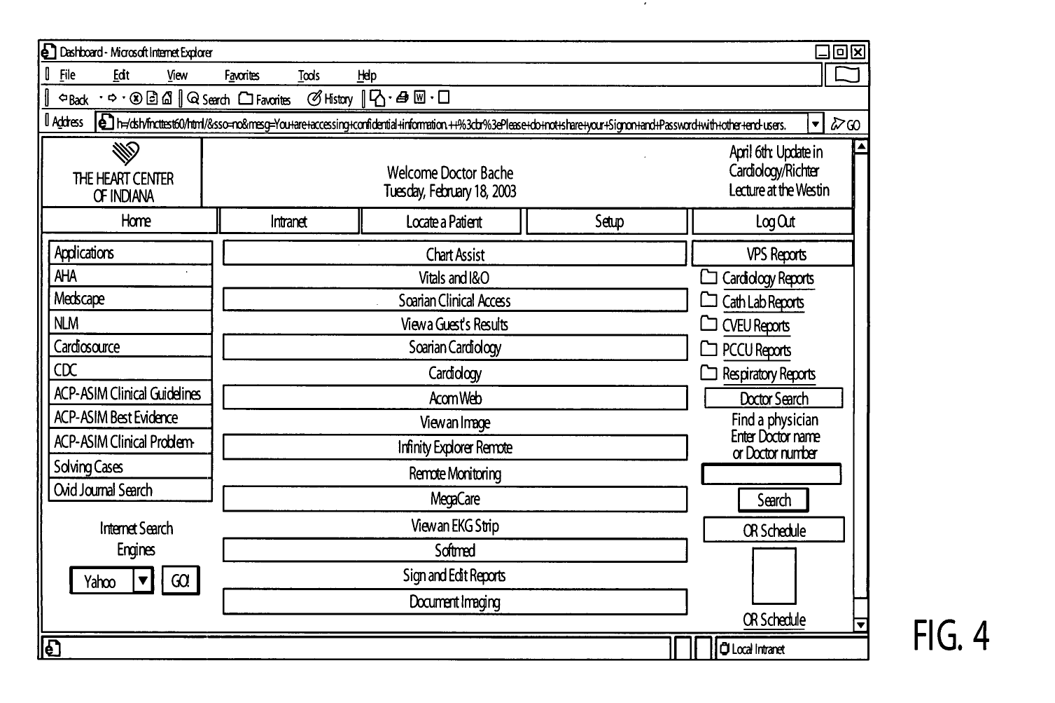

FIG. 4 is a display image window of one embodiment of an interface screen, the Dashboard screen described above, presented to a user subsequent to the user being authenticated in the manner described above. The Dashboard is displayed by the web portal browser 52 of station 11.

The Web portal browser 52 of the station 11 employs a flexible user interface supporting multiple functions with a common look and feel so that a user is readily trained to use different function stations for their respective different purposes e.g. Medication administration, surgery, anesthesia, etc. This is illustrated in FIG. 4 at the top portion of the Dashboard screen, the user (e.g., a doctor as determined via authentication means) is acknowledged by name, i.e., “Welcome Doctor Bache” and the date is provided. In the center of the user interface screen, the user (doctor) is provided with a menu listing of the various clinical applications 21 available for use by Doctor Bache (e.g., Chart Assist, Soarian Clinical Access, Soarian Cardiology, and so on).

Although this invention has been described with reference to particular embodiments, it should be appreciated that many variations can be resorted to without departing from the spirit and scope of this invention as set forth in the appended claims.

1. A mobile point-of-care medical station, comprising:
an interface processor for receiving user identification information;
a communication interface enabling communication with remote systems via a network;
a patient medical parameter processor for acquiring data representing a medical parameter of a patient and processing said patient medical parameter data for presentation to a user on a display; and
a session initiator for using said communication interface to communicate a message to a session management system employed by a plurality of mobile point-of-care medical stations and ensuring session management compatibility between medical stations, to initiate generation of a session identifier particular to a user initiated session of operation, in response to said received user identification information.

2. A system according to claim 1, wherein
said patient medical parameter processor is an executable application supporting patient medical parameter acquisition and including
an entitlement processor for authorizing user access to said patient medical parameter processor in response to said received user identification information by using said communication interface to communicate a message to an authorization management system employed by a plurality of mobile point-of-care medical stations and ensuring authorization management compatibility between medical stations.

3. A system according to claim 1, wherein
said interface processor,
said communication interface and
said patient medical parameter processor, are selected from a common set of components used by said plurality of mobile point-of-care medical stations and ensuring compatibility of said plurality of mobile point-of-care medical stations.

4. A system according to claim 3, wherein
said common set of components used by said plurality of mobile point-of-care medical stations include at least one of, (a) a workstation and (b) a plurality of executable applications supporting at least one of said interface processor, said communication interface and said patient medical parameter processor.

5. A system according to claim 1, wherein
said interface processor,
said communication interface and
said patient medical parameter processor, are adaptive to provide a mobile point-of-care medical station suitable for a selected function.

6. A system according to claim 5, wherein
said function is selected from, (a) Treatment, (b) Medication Delivery, (c) Anesthesia, (d) Isolation, (e) Emergency, (f) laboratory, (g) nursing, (h) intensive care and (i) pediatrics.

7. A system according to claim 1, including
an RFID processor for detecting an RFID tag within proximity of said mobile point-of-care medical station.

8. A system according to claim 1, including
an RFID processor for detecting an RFID tag within proximity of said mobile point-of-care medical station and for receiving user identification information from said RFID tag and providing said user identification information to said interface processor.

9. A system according to claim 8, wherein
said session initiator receives, via said communication interface, a message from said session management system, said received message including a generated session identifier particular to said user initiated session of operation and for use by a plurality of concurrently operating applications to uniquely identify said user initiated session.

10. A system according to claim 8, including
a first workstation and wherein
said session initiator uses said communication interface to communicate a message to said session management system to initiate detachment of an existing session of operation of an executable application connected to a second workstation and connection of said detached session to said first workstation, said existing session being initiated by said user.

11. A system according to claim 1, wherein
said session initiator receives, via said communication interface, a message from said session management system, said received message including a generated session identifier particular to said user initiated session of operation and for use by a plurality of concurrently operating applications to uniquely identify said user initiated session.

12. A system according to claim 1, wherein
said communication interface communicates via said network by wired or wireless communication and
said patient medical parameter processor processes at least one of, (a) blood parameter data, (b) ventilation parameter data, (c) infusion pump related data, (d) blood pressure data, (e) pulse rate data, (f) temperature data and (g) respiratory data.

13. A system according to claim 1, wherein
said communication interface supports voice over IP (VoIP) communication of said user with a remote system or person.

14. A system according to claim 1, including
a tracking processor for using said communication interface to communicate a message to a tracking management system, employed by a plurality of mobile point-of-care medical stations and ensuring tracking management compatibility between medical stations, to support monitoring and recording of user access to patient medical information.

15. A system for managing functions for a plurality of mobile point-of-care medical stations, comprising:
a communication interface enabling communication with a plurality of mobile point-of-care medical stations via a network; and
a session management system for using said communication interface in receiving a message from a particular mobile point-of-care medical station and for generating a session identifier particular to a user initiated session of operation of an executable application accessed by a user of said particular mobile point-of-care medical station, in response to said received message, said generated session identifier being compatible with session identifiers generated for other stations of said plurality of mobile point-of-care medical stations.

16. A system according to claim 15, wherein
said generated session identifier is compatible with session identifiers generated for other stations of said plurality of mobile point-of-care medical stations by being different in value and of similar data format to session identifiers generated for other stations of said plurality of mobile point-of-care medical stations.

17. A system according to claim 15, wherein
said session management system detaches an existing session of operation of an executable application connected to a workstation remote from said particular mobile point-of-care medical station and reconnects said detached session to a workstation of said particular mobile point-of-care medical station, said existing session being initiated by said user.

18. A system according to claim 17, wherein
said detachment and reconnection are performed in response to detection, by an RFID processor of said particular mobile point-of-care medical station, of an RFID tag within proximity of said particular mobile point-of-care medical station.

19. A system according to claim 15, including
an authorization management system for using said communication interface in communicating with a particular mobile point-of-care medical station and authorizing access by a user to an executable application via a workstation of said particular mobile point-of-care medical station, in response to a received user identification information and ensuring authorization management compatibility between stations of said plurality of mobile point-of-care medical stations.

20. A mobile point-of-care medical station, comprising:
a workstation;
an interface processor for receiving user identification information and a request initiated by a user of said workstation to access an executable application;
an entitlement processor for authorizing user access to said executable application in response to said received user identification information by communicating a message to an authorization management system employed by a plurality of mobile point-of-care medical stations and ensuring authorization management compatibility between medical stations; and
a session initiator for initiating generation of a session identifier particular to a user initiated session of operation of said executable application by communicating a message to a session management system employed by said plurality of mobile point-of-care medical stations and ensuring session management compatibility between said plurality of mobile point-of-care medical stations, in response to said request to access said executable application.

21. A method employed by a mobile point-of-care medical station, comprising the activities of:
receiving user identification information;
acquiring data representing a medical parameter of a patient;
processing said patient medical parameter data for presentation to a user on a display; and
communicating a message to a session management system, employed by a plurality of mobile point-of-care medical stations and ensuring session management compatibility between medical stations, to initiate generation of a session identifier particular to a user initiated session of operation said patient medical parameter processor, in response to said received user identification information.

22. A method for managing functions for a plurality of mobile point-of-care medical stations, comprising the activities of:
receiving a message from a particular mobile point-of-care medical station; and
generating a session identifier particular to a user initiated session of operation of an executable application accessed by a user of said particular mobile point-of-care medical station, in response to said received message, said generated session identifier being compatible with session identifiers generated for other stations of said plurality of mobile point-of-care medical stations.

23. A method employed by a mobile point-of-care medical station, comprising:
receiving user identification information and a request initiated by a user of said workstation to access an executable application;
authorizing user access to said executable application in response to said received user identification information by communicating a message to an authorization management system employed by a plurality of mobile point-of-care medical stations and ensuring authorization management compatibility between medical stations; and
initiating generation of a session identifier particular to a user initiated session of operation of said executable application by communicating a message to a session management system employed by said plurality of mobile point-of-care medical stations and ensuring session management compatibility between said plurality of mobile point-of-care medical stations, in response to said request to access said executable application.
